(19) United States
(12) Patent Application Publication
(10) Pub. No.: US 2003/0191845 A1
(43) Pub. Date: Oct. 9, 2003

(54) Method, apparatus and system for establishing communications between communications devices

(76) Inventor: John Sherman Hinds, McCordsville, IN (US)

Correspondence Address: JOSEPH S. TRIPOLI, THOMSON MULTIMEDIA LICENSING INC., 2 INDEPENDENCE WAY, SUITE #2, P.O. BOX 5312, PRINCETON, NJ, 08543-5312, US

(21) Appl. No.: 10/364,801

(22) Filed: Feb. 11, 2003

Related U.S. Application Data
(60) Provisional application No. 60/370,014, filed on Apr. 3, 2002.

(51) Int. Cl. G06F 15/16

(52) U.S. Cl. 709/227

(57) ABSTRACT

A method and apparatus for establishing communications between communications devices by examining data transmitted by each communications device and constructing a communications model for each communications device from the communications parameters associated with its transmitted data. Any data intended for each communications device is then adapted according to the communications model previously determined for that communications device.

### CROSS REFERENCE TO RELATED APPLICATIONS

This patent application claims the benefit of U.S. Provisional Application serial No. 60/370,014, filed Apr. 3, 2002, which is incorporated herein by reference in its entirety.

### FIELD OF THE INVENTION

This invention relates to the field of communications systems and, more specifically, to the interfacing and networking of communication devices.

### BACKGROUND OF THE INVENTION

The demand for home networks is rapidly increasing. Networks, and their associated network devices, allow consumers to interconnect their home computers as well as establish connections with outside networks. Unfortunately, the set up of a home network can be very difficult. In addition to the physical connection of the network devices, the current set-up of a home network requires the user to enter into the network devices, critical information, such as network settings and computer registry information. This information is necessary to establish communication paths between devices. Examples of some of these devices include personal computers, routers, switches, firewalls, and other types of network devices.

One of the greatest difficulties for consumers when installing a home network or device is making mistakes in the device set-up. Errors made during the set-up of a device result from either not reading or not understanding the manuals that come with the device. Additional errors arise out of the complexity of the interfacing methods and the protocol information for the devices as well as the number of device options available. Finally, errors come from simply mistyping communication protocol information into the network devices. Network device manufacturers are aware of this issue, but typically their responses have been limited to trying to improve the instruction manuals, providing on-line help, or providing live 1-800 number customer support. All of these have had limited success and present the manufacturer with increased costs.

### SUMMARY OF THE INVENTION

The invention comprises a method and apparatus for establishing communications between communications devices, such that user interaction is minimized and set up time may be reduced, while still providing accurate communication paths.

A method, according to one embodiment of the invention, for simplifying the communications interface between network devices includes, for each communications device, examining data transmitted by the device to determine the communications parameters associated with the communications device. The communications parameters are then used to construct a communications model of the communications device. Any data intended for the communications device is then adapted according to the communications model previously determined for the communications device.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of one embodiment of a communications system;

FIG. 2 depicts a high-level block diagram of a second embodiment of a communications system;

FIG. 3 depicts a high-level block diagram of an interfacing unit suitable for use in the system of FIG. 1 and FIG. 2; and

FIG. 4 depicts a flow diagram of a method for simplifying the communications interface between network devices in accordance with the principles of the present invention.

To facilitate understanding, identical reference numerals have been used, where possible, to designate identical elements that are common to the figures.

### DETAILED DESCRIPTION OF THE INVENTION

The subject invention will be described within the context of a network system and associated devices. However, it will be appreciated by those skilled in the art that the subject invention may be advantageously employed in any communications system in which devices utilizing various protocols are to be interfaced. Thus, it is contemplated by the inventors that the subject invention has broad applicability beyond the network systems described herein. The invention may be used to bridge between similar and dissimilar networks, protocols, and/or communication devices.

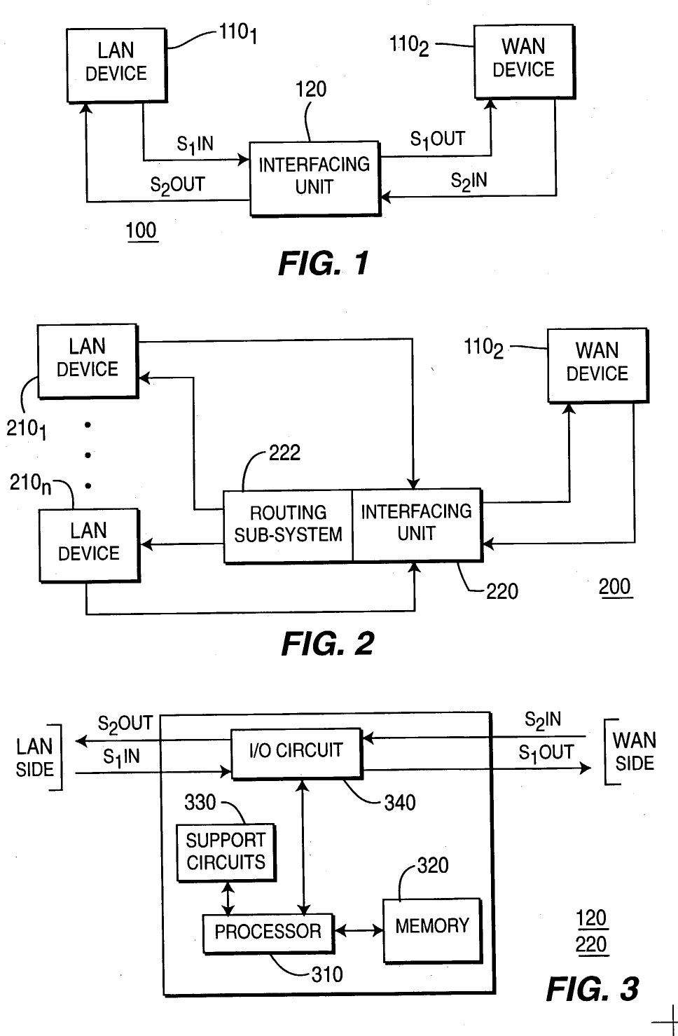

FIG. 1 depicts a high-level block diagram of one embodiment of a communications system. Specifically, the communication system 100 of FIG. 1 depicts a single local area network (LAN) device connected to a wide area network (WAN) device. The communications system 100 of FIG.1 includes two network devices, 110₁ and 110₂, connected to communicate in opposite directions through an interfacing unit 120 via signal paths S₁ and S₂. The communication system 100 of FIG. 1 provides interconnection between the LAN device 110₁ and the WAN device 110₂ such that data can be transferred bi-directionally. Briefly stated, any communication data from the LAN device 110₁ directed toward the WAN device 110₂ is channeled through the interfacing unit 120 via signal path S₁ and routed to the WAN device 110₂. Similarly, any communication data from the WAN device 110₂ directed toward the LAN device 110₁ is channeled in the opposite direction through the interfacing unit 120 via signal path S₂ and routed to the LAN devicel 110₁. Although the interfacing unit 120 in the communication system 100 of FIG. 1 is depicted as a separate unit, it should be noted the present invention can be advantageously incorporated in a modem (including, but not limited to a cable modem, a dial-up modem, a DSL modem, etc.), a set top box, a router, a switch, or any other existing network device.

Although only two network devices are depicted in FIG. 1, the communication system 100 may comprise a plurality of network devices 210₁ through 210ₙ (collectively network devices 210), each of said network devices 210 being connected to communicate in either one direction and/or the other through the interfacing unit 220 containing a Routing Sub-System 222 as depicted in FIG. 2. Additionally, the inputs to the interfacing unit 220 are not limited to network devices. For example, the inputs to the interfacing unit 220 may be from any devices that communicate using similar protocols.

As can be seen in FIG. 1, the LAN device 110₁ communicates with the WAN device 110₂ through the interfacing unit 120. The LAN device 110₁ transmits a communications packet to the interfacing unit 120. The composition of typical communications packets is well known to those skilled in the art and will not be described in detail herein. Basically, the communications packet includes a header, a trailer, and directional information. Upon receiving the communications packet from the LAN device 110₁, the interfacing unit 120 confirms communications initiation and creates an interchange ID for the LAN device 110₁. The interchange ID comprises communication protocols, including communication initiation and termination information for the LAN device 110₁. The communication direction of the interchange ID is recorded along with other packet information including all communications protocols, and a communications model is created. The communications model is used to establish settings for a proxy for the LAN device 110₁. The communications path through the interfacing unit 120 for communications from the WAN device 110₂, is then switched to pass through the newly created proxy. An alert is optionally sent to the user, notifying the user that the configuration was successful. On subsequent communication interchanges, a newly created communications model is compared to the existing communications model, and the existing communications model is modified to accommodate new information, if any.

The WAN device 110₂ communicates in the opposite direction as the LAN device 110₁ through the interfacing unit 120. Similar to the LAN device, the WAN device 110₂ transmits a communications packet to the interfacing unit 120. The communications packet includes a header, a trailer, and directional information. Upon receiving the communications packet from the WAN device 110₂, the interfacing unit 120 confirms communications initiation and creates an interchange ID for the WAN device 110₂. The interchange ID comprises communication protocols, including communication initiation and termination information for the WAN device 110₂. The communication direction of the interchange ID is recorded along with other packet information including all communications protocols, and a communications model is created. The communications model is used to establish settings for a proxy for the WAN device 110₂. The communications path through the interfacing unit for communications from the LAN device 110₁ is then switched to pass through the newly created proxy. An alert is optionally sent to the user, notifying the user that the configuration was successful. On subsequent communication interchanges, a newly created communications model is compared to the existing communications model, and the existing communications model is modified to accommodate new information, if any.

To increase the security of the interface or to shield the LAN device 110₁ from security threats in the network, optional parameters are set in the interfacing unit 120 to ensure that the only data sent to the LAN device 110₁ is data sent by the WAN device 110₂ in response to a query by the LAN device 110₁. Other forms of security measures are well known to those skilled in the art and will not be described in detail herein, but may be advantageously employed in any embodiment of the present invention.

FIG. 2 depicts a high-level block diagram 200 of a second embodiment of a communications system. Specifically, the communications system 200 of FIG. 2 depicts multiple local area network (LAN) devices 210₁ through 210ₙ connected to the WAN device 110₂. The communication system 200 of FIG. 2 provides interconnection between the multiple LAN devices 210₁ . . . 210ₙ (collectively LAN devices 210), and the WAN device 110₂ such that data can be transferred bi-directionally. Briefly stated, any communications data from the LAN devices 210 directed toward the WAN device 110₂ is channeled through the interfacing unit 220 and routed to the WAN device 110₂. Similarly, any communication data from the WAN device 110₂ directed toward the LAN devices 210 is channeled in the opposite direction through the interfacing unit 220 and routed to the LAN devices 210.

As can be seen in FIG. 2, the LAN devices 210 communicate with the WAN device 110₂ through an interfacing unit 220. Each of the LAN devices 210 transmits a communications packet to the interfacing unit 220. As stated previously above, the composition of typical communications packets is well known to those skilled in the art and will not be described in detail herein. As before, the communications packet includes a header, a trailer, and directional information, but in this case also includes additional information identifying from which of the LAN devices 210 the communications packet derived. Upon receiving the communications packet from the identified LAN device 210ᵢ, the interfacing unit 220 confirms communications initiation and creates an interchange ID for that identified LAN device 210ᵢ. The interchange ID comprises communication protocols, including communication initiation and termination information for the identified LAN device 210ᵢ. The communication direction of the interchange ID is recorded along with other packet information including all communications protocols, and a communications model is created. The communications model is used to establish settings for a proxy for the identified LAN device 210ᵢ. The communications path through the interfacing unit for the communications data from the WAN device 110₂ to the identified LAN device 210ᵢ is then switched to pass through the newly created proxy. The communications data is then channeled through the routing sub-system 222, which couples the communications data from the WAN device 110₂ to the identified LAN device 210ᵢ.

The interfacing unit 220 creates a communications path specific to each of the LAN devices 210 by means of the routing sub-system 222. Within the routing sub-system 222, specific proxies for each of the LAN devices 210 are created by means of the information contained in the communications packet identifying the specific LAN device from which the communications packet derived. The routing sub-system 222 subsequently couples the communications data from the WAN 110₂ to the specific LAN device for which it was intended. An alert can optionally be sent to the user at this point, notifying the user that the configuration was successful. On subsequent communication interchanges, a newly created communications model is compared to the existing communications model, and the existing communications model is modified to accommodate new information, if any.

Although the above embodiment of the communications system 200 was described implementing only one WAN device 110₂, it will be appreciated by those skilled in the art that the subject invention may be advantageously employed in communications systems in which more than one WAN device is implemented.

FIG. 3 depicts a high-level block diagram of one embodiment of an interfacing unit suitable for use in the communication systems of FIG. 1 and FIG. 2. The interfacing unit 120, 220 of FIG. 3 comprises a processor 310 as well as a memory 320 for storing information such as contained in the communications packets or generated proxies. The processor 310 cooperates with conventional support circuitry 330 such as power supplies, clock circuits, cache memory and the like as well as circuits that assist in executing the software routines stored in the memory 320. As such, it is contemplated that some of the process steps discussed herein as software processes may be implemented within hardware, for example, as circuitry that cooperates with the processor 310 to perform various steps. The interfacing unit 120, 220 also contains input-output circuitry 340 that forms an interface between the various functional elements communicating with the interfacing unit 120, 220. For example, in the embodiment of FIG. 1, the interfacing unit 120 communicates with the network devices 110 via signal paths S1 and S2.

Although the interfacing unit 120, 220 of FIG. 3 is depicted as incorporated within a general purpose processor that is programmed to perform various control functions in accordance with the present invention, the invention may also be implemented in hardware; for example, as an application specified integrated circuit (ASIC). As such, the process steps described herein are intended to be broadly interpreted as being equivalently performed by software, hardware, or a combination thereof.

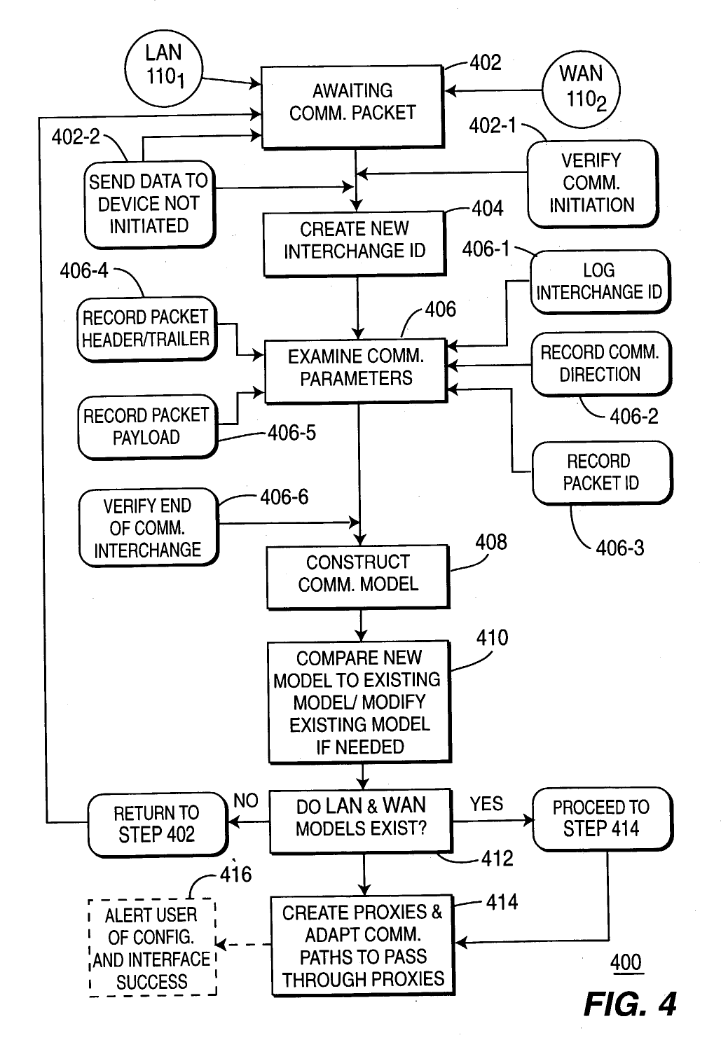

FIG. 4 depicts a flow diagram of one embodiment of a method 400 for simplifying the setup of a communications interface between network devices. The method 400 receives communication packets from both the LAN device and the WAN device and creates models for communications paths between the devices. These models are then used to direct communications between the devices. Although the method 400 will be described within the context of only interfacing the communication between one LAN device and one WAN device, it will be appreciated by those skilled in the art that the subject invention may be advantageously employed in methods where multiple LAN devices are interfaced with multiple WAN devices.

The method 400 is entered at step 402 where the interfacing unit 120 waits for a communications packet from either the LAN device 110₁ or the WAN device 110₂. If communications initiation is verified at step 402-1, the method 400 continues to step 404. If communications initiation is not verified at step 402-1, then the interfacing unit 120 continues to wait for communications packets from either the LAN device 110₁ or the WAN device 110₂, in accordance with step 402. Alternatively, if the interfacing unit 120 waits beyond a time-out period stored in memory 320, the interfacing unit 120 sends data to the device or devices that have not completed the communications initiation verification step 402-1 to cause transmission of data from that device(s) to the interfacing unit 120 as shown in step 402-2. The method 400 then returns to step 402 where the interfacing unit 120 waits for a communications packet from the device(s) not yet initiated.

At step 404, the method 400 creates a new interchange ID for the communications packet received from either the LAN device 110₁ or the WAN device 110₂.

At step 406, the method 400 examines and records all of the communications parameters included in the communications packet. That is at step 406, the interfacing unit 120 logs the interchange ID 406-1, records the communication direction 406-2, records the packet ID 406-3, records the header and trailer 406-4, and records the packet payload 406-5. If at step 406-6 the interfacing unit verifies the end of the communications interchange, the method 400 continues to step 408.

At step 408, the interfacing unit 120 constructs a communications model from the recorded information of step 406.

At step 410, the newly created communications model of step 408 is compared to an existing communications model if any, and the existing communications model is modified to accommodate new information, if any.

If at step 412 the interfacing unit 120 verifies that a communications model exists for both the LAN device 110₁ and the WAN device 110₂, the method proceeds to step 414. If not, the method 400 returns to step 402 and waits for a communications packet from the device missing a communications model.

At step 414, the interfacing unit 120 creates communication proxies for the LAN device 110₁ and the WAN device 110₂ and adapts the communication paths in the interfacing device 120 to pass through the proxies. Briefly stated, for each communications device, the data intended for each communications device is adapted to pass through the interfacing unit 120 according to the communications model created in step 408 for each communications device. The model for each communications device includes the communication protocol and parameters necessary to establish communications with the communications devices; for example the addresses and registry information of the communications devices. The communications proxies are created according to the model created in step 408.

Step 416, optionally alerts the user that the configuration and interfacing was a success.

The method 400 can be configured to loop continuously or at a predetermined interval.

While the forgoing is directed to some embodiments of the present invention, other and further embodiments of the invention may be devised without departing from the basic scope thereof. As such, the appropriate scope of the invention is to be determined according to the claims, which follow.

What is claimed is:

1. A method for establishing communications between a plurality of communications devices, comprising:
for each communications device, examining transmitted data to determine communications parameters associated with said each communications device, said communications parameters being used to construct a communications model of said each communications device; and
for said each communications device, adapting data intended for said each communications device according to said communications model previously determined for said each communications device.

2. The method of claim 1, further comprising:
in the absence of a constructed communications model for an intended communications device, sending data to said intended communications device adapted to cause transmission of data by the intended communications device.

3. The method of claim 1, further comprising:
verifying that said transmitted data satisfies security requirements set by said each communications device for receiving data.

4. The method of claim 1, wherein said communications parameters comprise the addresses and registry information of the communications devices.

5. The method of claim 1, wherein said plurality of communications devices are network devices.

6. An interfacing unit for establishing communications between a plurality of communications devices, comprising:
a memory for storing communications parameters and instructions; and
a processor, upon executing said instructions, configured to:
for each communications device, examine transmitted data from said each communications device to determine communications parameters associated with said each communications device, said communications parameters being used to construct a communications model of said each communications device; and
for said each communications device, adapt data intended for said each communications device according to the communications model determined for said each communications device.

7. The interfacing unit of claim 6, wherein said processor is further configured to:
in the absence of a constructed communications model for an intended communications device, send data to said intended communications device adapted to cause transmission of data by the intended communications device.

8. The interfacing unit of claim 6, wherein said processor is further configured to:
verify that said transmitted data satisfies security requirements set by the communications devices for receiving data.

9. The interfacing unit of claim 6, wherein said communications parameters comprise the addresses and registry information of the communications devices.

10. The interfacing unit of claim 6, wherein said plurality of communications devices are network devices.

11. A communications system comprising:
at least one first communications device configured to transmit data in a first direction;
at least one second communications device configured to transmit data in a second direction, opposite the first direction; and
an interfacing unit comprising:
a memory for storing communications information and instructions; and
a processor, upon executing said instructions, configured to:
for each communications device, examine transmitted data from said each communications device to determine communications parameters associated with said each communications device, said communications parameters being used to construct a communications model of said each communications device; and
for said each communications device, adapt data intended for said each communications device according to the communications model determined for said each communications device.

12. The communications system of claim 11, wherein said processor is further configured to:
in the absence of a constructed communications model for an intended communications device, send data to said intended communications device adapted to cause transmission of data by the intended communications device.

13. The communications system of claim 11, wherein said processor is further configured to:
verify that said transmitted data satisfies security requirements set by the communications devices for receiving data.

14. The communications system of claim 11, wherein said communications parameters comprise the addresses and registry information of the communications devices.

15. The communications system of claim 11, wherein said at least one first communications device is a network device.

16. The communications system of claim 11, wherein said at least one second communications device is a network device.

17. Computer-readable medium for storing a set of instructions, wherein when said set of instructions is executed by a processor perform a method comprising:
for each communications device, examining transmitted data to determine communications parameters associated with said each communications device, said communications parameters being used to construct a communications model of said each communications device; and
for said each communications device, adapting data intended for said each communications device according to said communications model previously determined for said each communications device.

18. An apparatus for establishing communications between a plurality of communications devices, comprising:
means for examining transmitted data from each communications device to determine communications parameters associated with said each communications device, said communications parameters being used to construct a communications model of said each communications device; and
means for adapting data intended for said each communications device according to said communications model previously determined for said each communications device.

19. The interfacing unit of claim 6, wherein said interfacing unit is incorporated within a network device.

20. The interfacing unit of claim 19, wherein said network device is selected from the group including a modem, a cable modem, a dial-up modem, a DSL modem, a set top box, a router, and a switch.
